(19) United States
(12) Patent Application Publication
(10) Pub. No.: US 2004/0262807 A1
(43) Pub. Date: Dec. 30, 2004

(54) Method for continuous mixing and preparation processes by means of special ratios of the lateral surface and the free volume and/or internal and external diameter of the screw

(75) Inventors: Achim-Philipp Sturm, Niederuzwil (CH); Jurgen Schweikle, Niederhelfenschwil (CH); Andreas Christel, Zuzwil (CH); Christoph Naf, Winterthur (CH); Federico Innerebner, Zurich (CH)

Correspondence Address: BURNS DOANE SWECKER & MATHIS L L P, POST OFFICE BOX 1404, ALEXANDRIA, VA, 22313-1404, US

(73) Assignee: BUHLER, AG

(21) Appl. No.: 10/796,099

(22) Filed: Mar. 10, 2004

Related U.S. Application Data
(63) Continuation of application No. PCT/CH02/00500, filed on Sep. 11, 2002.

(30) Foreign Application Priority Data
Sep. 11, 2001 (DE) 101 44 748.5
Sep. 3, 2002 (DE) 102 41 117.4

(51) Int. Cl. B29C 47/60

(52) U.S. Cl. 264/211.23

(57) ABSTRACT

A method is disclosed wherein synthetic materials and elastomers (e.g., PET or rubber) can be carefully processed with throughput amounts which are so high as to improve the quality of the final product and increase the cost-effectiveness of the entire process. Process tasks such as mixing, cooling/heating (heat exchange) and de-gasing (exchange of materials) can be carried out simultaneously and with greater efficiency.

### CROSS REFERENCE TO RELATED APPLICATIONS

This application claims priority under 35 U.S.C. §119 to German Application Nos. 101 44 748.5 filed in Germany on Sep. 11, 2001 and 102 41 117.4 filed in Germany on Sep. 3, 2002, and as a Continuation Application under 35 U.S.C. §120 to PCT/CH02/00500 filed as an International Application on Sep. 11, 2002 designating the U.S., the entire contents of which are hereby incorporated by reference in their entireties.

### BACKGROUND

A method is disclosed for the continuous processing of a product by means of a multi-shaft extruder rotating in the same sense.

Such a method has been described in prior art, e.g. in DE 195 36 289 C2. The method described therein can be used for the processing of plastics, in particular resins and viscoplastic masses, on a twin-shaft extruder. To minimize thermal, thermochemical, and purely mechanical impairment of product quality during processing of this product, according to this method, the residence time of the product in the extruder is kept short. This is achieved by using a high number of rotation speeds in combination with high torque densities to process a high volume of throughput. At the same time, however, the high free volume (processing space volume) in the extruder remains unchanged.

The resulting mechanical and thermal stress on the product, however, can lead to unacceptably high product damage, in particular in the case of processing polycondensates, such as polyesters, or elastomers, e.g. rubber mixtures.

### SUMMARY

A method is disclosed for the preparation and processing of highly viscous products (such as polymers, emulsions, etc.) where excessive temperatures and/or excessive residence times in the extruder cause quality-impairing of in the product during processing.

The residence time of the product in the extruder can be reduced without requiring an extremely high speed of rotation, which is achieved by reducing the free volume (processing space volume) in the extruder.

In the method, the processing space, with a smooth lateral area Am (housing surface), a free volume Vf as well as the outer diameter of the screw Da and the internal diameter of the screw Di of the screws rotating only with respect to their own axis in the same sense and also having a smooth surface, is designed in such a manner that at least one part of the processing area has a ratio Am³/Vf² between 1020 and 3050 for twin screw elements and a ratio Am³/Vf² between 2000 and 7300 for triple screw elements at a Da/Di ratio of 1.3 to 1.7. In this context, the free volume Vf refers to the receiving capacity of the components that are supplied. Each volume unit of the product is provided with a large surface for cooling/heating and degassing the product, which permits smooth handling of the educts that are supplied and, therefore, high quality of the final product. The smooth lateral area of the extruder processing space and the smooth surface of the self-cleaning screws ensure that the extruder is fully self-cleaning.

Smooth processing of the educts is achieved by means of a plurality of screws with the smallest possible screw diameter, coupled with low speeds of rotation of up to 600 rpm. The resulting shearing and kneading forces hardly impair the product. The plurality of screws results in a short length of the process step with a high ratio between the surface and the free volume.

A comparison with other mixing aggregates can be based on the same free volume.

The ratio between the surface and the free volume refers to the condition at the same free volume, compared with other mixing aggregates.

It is advisable to apply to the extruder a torque density (torque per screw/axis distance³) of at least 7 Nm/cm³ and, in particular, at least 9 Nm/cm³. A higher torque density permits a higher performance input at the same speed of rotation, therefore leads to in increased throughput and, as a result thereof, a shorter residence time, as a result of which the heating of the educts that are supplied decreases throughout the process; therefore, a lower thermal damage of the products can be achieved.

In combination with a high drive torque, a high throughput and, therefore, a short residence time can be achieved, which positively impacts the product temperature.

The Da/Di ratio can, for example, be chosen from 1.5 to 1.63.

It can be advantageous to select the Am³/Vf² ratio in such a manner that in twin screw elements, such ratio is 1500<Am³/Vf²<2030, and in triple screw elements, such ratio is 3000<Am³/Vf²<5090.

The educt to be processed is a contaminated and/or humid polycondensate, in particular a polyester, such as a polyester recyclate. The polyester recyclate can, for example, be a PET bottle recyclate. The disclosed method can be particularly suited herefor since the large specific surface favors drying and degassing of the product, as a result of which undesired volatile components of the polycondensate are removed to a large extent. In this respect, the removal of water molecules from the polycondensate which lead to hydrolysis of the chain molecules and therefore the decrease in the intrinsic viscosity of the polycondensate is of particular importance. The large specific surface and, as a result thereof, improved cooling of the product and the improved degassing of any oxidative contamination also reduces the purely thermal as well as thermooxidative reduction of the chain molecules. Overall, this leads to a less damaging treatment and, consequently, a high quality of the product, in addition to making the method very economical.

In the method, the processing space, with a smooth wedge surface Az, a free volume Vf as well as the outer diameter Da and the internal diameter Di of the screws rotating only with respect to their own axis in the same sense and also having a smooth surface, is designed in such a manner that at least one part of the processing area has a ratio Az³/Vf² between 0.5 and 2.11 for twin screw elements and a ratio Az³/Vf² between 0.02 and 1.50 for triple screw elements at a Da/Di ratio of 1.3 to 1.7. The high percentage of wedge areas leads to a high number of rearrangement processes and therefore good mixing properties. In particular in case several wedge areas are used, increased axial flow of the material is achieved, which contributes to reducing the residence time of the product in the extruder. Once again, the product is processed in a less impairing manner by using a plurality of screws with the lowest possible screw diameter in combination of low speeds of rotation of up to 600 rpm. The resulting shearing and kneading forces hardly impair the product. The plurality of screws results in a short length of the processing step with a high ratio between the specific wedge surface and the free volume. Once again, the smooth wedge area and the smooth surface of the self-cleaning screws ensure complete self-cleaning of the processing space.

A comparison with other mixing aggregates can be based on the same free volume.

Once again, it is advisable to apply to the extruder a torque density (torque per screw/axis distance³) of at least 7 Nm/cm³ and, in particular, at least 9 Nm/cm³. A higher torque density permits a higher performance input at the same speed of rotation, therefore resulting in increased throughput and, as a result thereof, a shorter residence time, as a result of which the heating of the product decreases throughout the process, and therefore, lower thermal damage of the products can be achieved.

Once again, in combination with a high drive torque, a high throughput and, therefore, a short residence time can be achieved which positively impacts the product temperature.

The Da/Di ratio can, for example, be chosen from 1.5 to 1.63.

It is particularly advantageous to select the Am³/Vf² ratio in such a manner that in twin screw elements, such ratio is between 1020 and 3050 and in triple screw elements, the Am³/Vf² ratio is between 2000 and 7300, and one of the components supplied is an elastomer.

Because of the high number of wedge areas, an increased surface formation rate is achieved to moisten the components that are supplied, in particular to moisten the elastomer with the softening agent. Once again, the large specific surface provides a large cooling surface which, in combination with the high throughput and the high axial speeds in the wedge areas, ultimately leads to a low-impact treatment of the components. Low rotational speeds of the screws, high torque densities in combination with a small free volume, and a sufficiently high throughput lead to lower in-process temperatures.

In another exemplary embodiment of the method, the Am³/Vf² ratio is between 1500 and 2300 for twin screw elements, and between 3000 and 5090 for triple screw elements.

Advantageously, the elastomer is a powdery or granulated elastomer in which a filling agent has already been incorporated, e.g. as in the case of powder rubber.

It is furthermore advantageous to use dense-comb screw elements whose self-cleaning effect contributes to low thermal impairment of the product.

The disclosed method can be carried out by using an extruder which has at least four individually driven screws.

Another improvement in terms of cooling is achieved by using an extruder with a temperature-controllable core and a temperature-controllable housing which are both stationary; depending on the requirements, the temperature of the core and the housing can also be controlled separately. For that purpose, it is advisable to divide the housing into segments whose temperatures can be controlled separately.

The disclosed method can also be carried out by using an extruder whose screws are disposed in a coronary configuration, in particular an annular configuration.

It is advisable to apply the polycondensate during the method in a molten state and later harden the same, wherein the total period during which the temperature of the polycondensate, throughout the process, is above the melting temperature of the polycondensate, is less than approx. 60 seconds, preferably less than roughly 30 seconds. As a result, there is little time for any hydrolytic decomposition reactions which may occur. This makes it possible to use a residual water content of more than 200 ppm in the melt, which is actually high, without having to cope with a IV reduction of more than 0.05 dl/g.

In its initial form, the polycondensate can be a bulk material with a bulk density in the range from 200 kg/m³ to 600 kg/m³, particularly in the form of chips or chippings.

It is advisable to partially pre-dry the initial polycondensate material prior to application in the molten state. This makes it possible to obtain, as a combination of uncomplicated partial drying with the short residence time in the molten state, a final product with little IV reduction. The method can include a degassing step during which volatile contaminations and/or decomposition products are removed from the polycondensate.

The polycondensate can be placed in the extruder in the solid state, and the polycondensate is heated to a temperature below the melting point, and the polycondensate is degassed and/or dried in the process. Degassing and/or drying of the polycondensate in the solid state is carried out, at a pressure below the atmospheric pressure and/or while adding an inert gas.

One particular feature of the method is that the total time during which the polycondensate is in the molten state during processing comprises a first period during which the polycondensate still remains in the extruder after application in the molten state and a second period during which the polycondensate, which is still in the molten state, is processed outside of the extruder, wherein the first period is, for example, less than approx. 15 seconds. A residence time of the melt in the extruder of less than approx. 10 seconds is particularly advantageous.

Processing of the molten polycondensate outside of the extruder can contain a step of filtering the melt to remove contaminating particles. To create the necessary pressure, a melt pump can, for example, be used. For that purpose, the melt pump and the melt filter can be integrated in the process in such a manner that the short residence time is maintained.

Upon hardening, the polycondensate can be processed to form a granulate made up of pellets.

A method is therefore disclosed which makes it possible to process viscous and viscoelastic materials such as thermoplasts and elastomers in the most non-damaging manner possible and with the highest possible throughput rate to improve the quality of the final product and reduce the costs of the entire process. Important process steps such as mixing, cooling/heating (heat exchange), and degassing (exchange of material) can be performed simultaneously and in a highly efficient manner.

As a system for this method, for example, a multi-shaft extruder rotating in the same sense, in particular an annular twelve-shaft extruder is suited, although other constructive types, such as non-annular multi-shaft extruders or annular extruders with a different number of shafts may also be used.

The economics of the method can be improved as soon as, for a processing step, for the smallest possible constructive size of the processing machinery, the highest possible processing quantity (throughput) is attained.

Low-impact processing of the product leads to an improvement of the following quality characteristics, among others:

Degree of damage of the final product, e.g. low thermal damage of the product.

Quality of mechanical properties of the final product, e.g. a good degree of dispersion.

Low-impact processing of the product is achieved by the following measures, among others:

Required high but uniform shearing stress.

Short residence time in the extruder.

High throughput.

High ratio wedge surface/free volume (Az³/Vf²).

High ratio specific surfaces/free volume (Am³/Vf²).

Narrow range of residence times as a result of self-cleaning screw elements.

A high torque density can be used which permits the high throughputs which are responsible for product quality.

The disclosed processing steps can be performed in a highly efficient manner by undertaking the following measures, among others:

Frequent rearrangement of the material.

High ratio between the specific surface/free volume (Am³/Vf²) at the same time as a high surface formation rate (heat and material exchange).

A multi-shaft extruder, on which this method is based, has a large number of wedges while the free volume is kept very low. One advantage of such machines is improved distribution, dispersion, and mixing of the product.

A comparison was made between an exemplary process of the disclosed method on an annular twelve-shaft extruder and a method using a twin-shaft extruder.

During each rotation of the screw, a twelve-shaft extruder mixes the material twelve times more frequently than a twin-shaft extruder. The rearrangement ratio U between the twelve-shaft extruder and the twin-shaft extruder is therefore

U=12:1

The distribution, dispersion, and mixing of the product are characterized by the dimensionless characteristic number of the ratio between the wedge area³, Az³, and the free volume², Vf².

The tempering and degassing performance of the method is characterized by the dimensionless characteristic number of the ratio between the surface³ (Am³) and the free volume² (Vf²).

To calculate the wedge surface, the Booy relationships¹ were used. ¹ M. L. Booy; Isothermal Flow of Viscous Liquids in Corotating Twin-Screw Devices; Polymer Engineering and Science, December 1980, Vol. 20, No. 18.

The value of the ratio Az³/Vf² includes the mixing ratio or the mixing factor U.

In a multi-shaft extruder, large surfaces (screw and housing surface) while the free volume is kept very low. Another advantage of the use of such machines is therefore that the high ratio between the specific surface and the volume is utilized.

This dimensionless characteristic value is formed by the ratio between the bore surface³, Am³, and the free volume², Vf².

Tests using an annular twelve-shaft extruder have shown the suitability of such a machine for processes where good distribution and dispersion, mixing, cooling, and degassing are of crucial importance.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method for continuous preparation of a product comprising:
preparing a product using a fully self-cleaning, multi-shaft extruder rotating in a same sense, whose processing area comprises a lateral area Am and a free volume Vf and whose screws, which also have a smooth surface, rotate only with respect to their own axis, wherein screw elements have, on a screw bridge, an outer diameter Da and, on a screw bottom, an internal diameter Di, wherein at least one part of the processing area has at least one of: a ratio Am³/Vf² between 1020 and 3050 for twin screw elements, and a ratio Am³/Vf² between 2000 and 7300 for triple screw elements, at a Da/Di ratio of 1.3 to 1.7.

2. The method in accordance with claim 1, comprising:
applying a torque density (torque per screw/axis distance³) of at least 7 Nm/cm³ to the extruder.

3. The method in accordance with claim 1, comprising:
applying a torque density (torque per screw/axis distance³) of at least 9 Nm/cm³ to the extruder.

4. The method in accordance with claim 1, wherein the Da/Di ratio is 1.5 to 1.63.

5. The method in accordance with claim 1, wherein the ratio for twin screw elements is 1500<Am³/Vf²<2020 and the ratio for triple screw elements is 3000<Am³/Vf²<5090.

6. The method in accordance with claim 1, wherein the product to be processed is a contaminated and/or humid polycondensate.

7. The method in accordance with claim 6, wherein the polycondensate to be processed is polyester.

8. The method in accordance with claim 7, wherein the polycondensate to be processed is a polyester PET bottle recyclate.

9. A method for continuous preparation of a product comprising:
preparing a fully self-cleaning, multi-shaft extruder rotating in the same sense, whose processing area comprises a wedge surface Az and a free volume Vf and whose screws, which also have a smooth surface, rotate only with respect to their own axis, wherein screw elements have, on a screw bridge, an outer diameter Da and, on a screw bottom, an internal diameter Di, wherein at least one part of the processing area has at least one of: a ratio Az³/Vf² between 0.5 and 2.11 for twin screw elements, and a ratio Az³/Vf² between 0.02 and 1.50 for triple screw elements, at a Da/Di ratio of 1.3 to 1.7.

10. The method in accordance with claim 9, comprising:
applying a torque density (torque per screw/axis distance³) of at least 7 Nm/cm³ to the extruder.

11. The method in accordance with claim 9, comprising:
applying a torque density of more than 9 Nm/cm³ to the extruder.

12. The method in accordance with claim 9, wherein the Da/Di ratio is 1.5 to 1.63.

13. The method in accordance with claim 9, wherein the at least one part of the processing area has an Am³/Vf² ratio between 1020 and 3050 for twin screw elements and an Am³/Vf² ratio between 2000 and 7300 for triple screw elements, and an educt component supplied is an elastomer.

14. The method in accordance with claim 9, wherein the Am³/Vf² ratio is between 1500 and 2300 for twin screw elements, and the Am³/Vf² ratio is between 3000 and 5090 for triple screw elements.

15. The method in accordance with claim 13, wherein the elastomer is a powdery or granulated elastomer in which at least one filling agent has already been incorporated.

16. The method in accordance with claim 1, wherein the screw elements are provided with dense combs.

17. The method in accordance with claim 1, wherein the extruder has at least four individually driven screws.

18. The method in accordance with claim 1, wherein the extruder has a temperature-controllable core and a temperature-controllable housing which are both stationary.

19. The method in accordance with claim 18, wherein the temperature of the core and of the housing are controlled separately.

20. The method in accordance with claim 18, wherein the housing is divided into segments whose temperature is controlled separately.

21. The method in accordance with claim 1, wherein the screws are disposed in a coronary annular configuration.

22. The method in accordance with claim 6, wherein during processing, the polycondensate is applied in a molten state and later hardened, wherein a total period during which a temperature of the polycondensate is above a melting temperature of the polycondensate during processing is less than approx. 60 seconds.

23. The method in accordance with claim 22, wherein the total period during which the temperature of the polycondensate is above the melting temperature of the polycondensate during processing is less than roughly 30 seconds.

24. The method in accordance with claim 22, wherein a content of residual water in the melt exceeds 200 ppm.

25. The method in accordance with claim 22, wherein, in its initial form, the polycondensate is a bulk material with a bulk density in a range from 200 kg/m³ to 600 kg/m³.

26. The method in accordance with claim 22, wherein the polycondensate is present as chips or chippings.

27. The method in accordance with claim 22, wherein the polycondensate material is initially, partially pre-dried prior to application in a molten state.

28. The method in accordance with claim 22, comprising:
a degassing step during which volatile contaminations and/or decomposition products are removed from a polycondensate melt.

29. The method in accordance with claim 22, wherein the polycondensate is placed in the extruder in a solid state, the polycondensate is heated to a temperature below a melting point, and the polycondensate is degassed and/or dried at a pressure below atmospheric pressure and/or while adding an inert gas.

30. The method in accordance with claim 29, wherein a total time during which the polycondensate is in the molten state during the process comprises a first period during which the polycondensate remains in the extruder after application in the molten state and a second period during which the polycondensate, which is still in the molten state, is processed outside of the extruder.

31. The method in accordance with claim 30, wherein a duration of the first period is less than approx. 15 seconds.

32. The method in accordance with claim 30, wherein a duration of the first period is less than approx. 10 seconds.

33. The method in accordance with claim 29, wherein processing of the molten polycondensate outside of the extruder includes filtering of the melt.

34. The method in accordance with claim 29, wherein the processing of the molten polycondensate outside of the extruder includes using a melt pump.

35. The method in accordance with claim 22, wherein upon hardening, the polycondensate is processed to form a granulate made up of pellets.

36. The method in accordance with claim 9, wherein the screw elements are provided with dense combs.

37. The method in accordance with claim 9, wherein the extruder has at least four individually driven screws.

38. The method in accordance with claim 9, wherein the extruder has a temperature-controllable core and a temperature-controllable housing which are both stationary.

39. The method in accordance with claim 9, wherein the screws are disposed in a coronary annular configuration.
